(19) United States
(12) Patent Application Publication
(10) Pub. No.: US 2023/0037364 A1
(43) Pub. Date: Feb. 9, 2023

(54) IMAGE FORMING APPARATUS, INFORMATION PROCESSING APPARATUS, AND NON-TRANSITORY COMPUTER READABLE MEDIUM

(71) Applicant: FUJIFILM Business Innovation Corp., Tokyo (JP)

(72) Inventor: Hisao KOMAZAWA, Kanagawa (JP)

(73) Assignee: FUJIFILM Business Innovation Corp., Tokyo (JP)

(21) Appl. No.: 17/541,214

(22) Filed: Dec. 2, 2021

(30) Foreign Application Priority Data
Aug. 3, 2021 (JP) 2021-127330

(51) Int. Cl. G06F 3/12

(52) U.S. Cl. CPC G06F 3/1208; G06F 3/1226; G06F 3/1256

(57) ABSTRACT

An image forming apparatus includes a processor configured to: receive, from each of plural print image data generation apparatuses that generate plural pieces of print image data on a basis of a print instruction, the plural pieces print image data corresponding to the print instruction; and notify a user of a result of comparison between sample data indicating a feature of a print result desired with the print instruction and the plural pieces of print image data.

### CROSS-REFERENCE TO RELATED APPLICATIONS

This application is based on and claims priority under 35 USC 119 from Japanese Patent Application No. 2021-127330 filed Aug. 3, 2021.

### BACKGROUND

### (i) Technical Field

The present disclosure relates to an image forming apparatus, an information processing apparatus, and a non-transitory computer readable medium.

### (ii) Related Art

Japanese Patent No. 6070706 discloses a cloud service selection system for selecting a cloud service to be provided for a user over a communication network. In the cloud service selection system, data indicating performance of cloud services desired by the user is registered in advance, and a cloud service that suits the user's desire is selected from plural cloud services.

### SUMMARY

Print image data generation apparatuses, which are different from image forming apparatuses, sometimes perform, on the basis of print instructions, a process for generating print image data that can be processed by the image forming apparatuses (e.g., raster image data such as bitmap data). Such print image data generation apparatuses may be, but are not limited to, servers that provide generation of print image data as a cloud service.

In this case, even if the print image data generation apparatuses generate print image data on the basis of the same print instruction, the generated print image data might be slightly different between the print image data generation apparatuses. In addition, even with the same print image data generation apparatus, print image data based on the same print instruction might be slightly different before and after a specification change or upgrading of the print image data generation apparatus.

Similarly, when plural image forming apparatuses perform a printing process on the basis of the same print image data, print results produced by the image forming apparatuses might be slightly different from one another. In addition, even with the same image forming apparatus, a print result based on the same print image data might be slightly different before and after a specification change or upgrading of the image forming apparatus.

Aspects of non-limiting embodiments of the present disclosure relate to a mechanism for enabling a user to select, from among plural print image data generation apparatuses, a print image data generation apparatus for obtaining a print result desired by the user. The aspects of the non-limiting embodiments of the present disclosure also relate to a mechanism for enabling a user to select, from among plural image forming apparatuses, an image forming apparatus for obtaining a print result desired by the user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a processor configured to: receive, from each of a plurality of print image data generation apparatuses that generate a plurality of pieces of print image data on a basis of a print instruction, the plurality of pieces of print image data corresponding to the print instruction; and notify a user of a result of comparison between sample data indicating a feature of a print result desired with the print instruction and the plurality of pieces of print image data.

### BRIEF DESCRIPTION OF THE DRAWINGS

Exemplary embodiments of the present disclosure will be described in detail based on the following figures, wherein:

FIG. 1 is a schematic diagram illustrating the configuration of an image processing system according to a first exemplary embodiment;

FIG. 2 is a schematic diagram illustrating the configuration of a controller;

FIG. 3 is a conceptual diagram illustrating an example of metadata as sample data;

FIG. 4 is a diagram illustrating an example of a comparison result notification screen;

FIG. 5 is a flowchart illustrating a process performed by the controller according to the first exemplary embodiment;

FIG. 6 is a schematic diagram illustrating the configuration of an image processing system according to a second exemplary embodiment;

FIG. 7 is a schematic diagram illustrating the configuration of a raster image data generation apparatus; and

FIG. 8 is a flowchart illustrating a process performed by the raster image data generation apparatus according to the second exemplary embodiment.

### DETAILED DESCRIPTION

### First Exemplary Embodiment

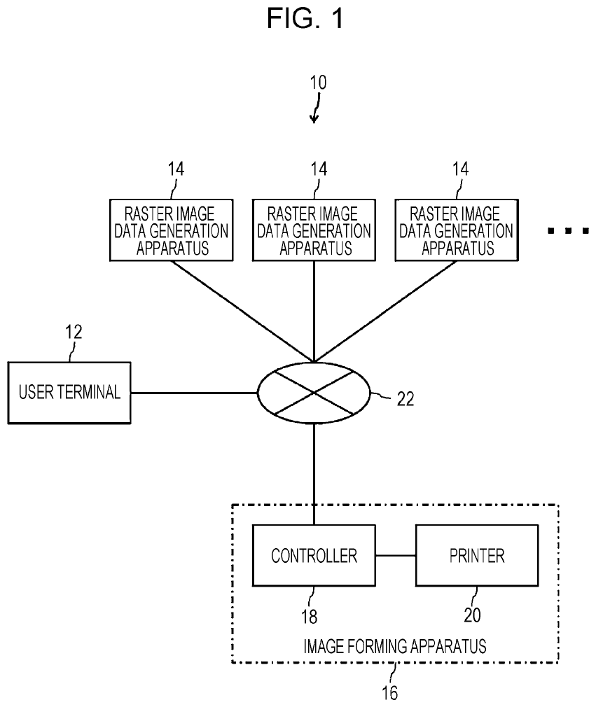

FIG. 1 is a schematic diagram illustrating the configuration of an image processing system 10 according to a first exemplary embodiment. The image processing system 10 includes a user terminal 12 used by a user, plural raster image data generation apparatuses 14, and an image forming apparatus 16. As illustrated in FIG. 1, the image forming apparatus 16 includes a controller 18 and a printer 20. The user terminal 12, the raster image data generation apparatuses 14, and the controller 18 are communicably connected to one another over a communication network 22 such as a local area network (LAN), the Internet, or a mobile communication network.

The image processing system 10 performs, on the basis of a print job as a print instruction from the user, a process for printing print image data based on the print job on a print medium such as sheets of paper using the image forming apparatus 16. More specifically, the user terminal 12 transmits a print job to the controller 18, the raster image data generation apparatuses 14 generate, in response to a request from the controller 18, raster image data as print image data, which is image data that can be recognized by the printer 20, on the basis of the print job and transmits the raster image data to the controller 18, the controller 18 transmits the raster image data to the printer 20, and the printer 20 performs a printing process on the basis of the raster image data.

Plural raster image data generation apparatuses 14 for generating raster image data are provided in the image processing system 10. A selected one of the raster image data generation apparatuses 14, therefore, generates raster image data, and the printer 20 performs a printing process on the basis of the raster image data. Here, even when plural raster image data generation apparatuses 14 generate raster image data on the basis of the same print job, the generated raster image data might be slightly different between the raster image data generation apparatuses 14. For example, colors and printing positions of objects might be slightly different between the raster image data generation apparatuses 14. That is, even with the same print job, a print result obtained through the printing process performed by the printer 20 might be slightly different depending on a raster image data generation apparatus 14 that generates raster image data. This is due to, but not limited to, differences in a method employed by the raster image data generation apparatuses 14 for a process for generating raster image data (e.g., differences in a program for generating raster image data).

The image processing system 10 assists the user in selecting a raster image data generation apparatus 14 that generates raster image data with which a print result desired by the user can be obtained, details of which will be described later.

The user terminal 12 may be, for example, a personal computer or a tablet terminal. The user terminal 12 includes, for example, a communication interface such as a network adapter, a display such as a liquid crystal panel, an input interface such as a mouse, a keyboard, or a touch panel, a memory such as a hard disk drive (HDD), a solid-state drive (SSD), an embedded MultiMediaCard (eMMC), a read-only memory (ROM), or a random-access memory (RAM), and a processor such as a central processing unit (CPU). The user terminal 12 transmits a print job to the controller 18 in accordance with an instruction from the user.

The raster image data generation apparatuses 14 are apparatuses other than the image forming apparatus 16 and, as described above, perform the process for generating raster image data on the basis of a print job. The raster image data generation apparatuses 14 may be server computers communicably connected to the user terminal 12 and the image forming apparatus 16 over the Internet. More specifically, the raster image data generation apparatuses 14 may be cloud servers that provide the process for generating raster image data as a cloud service. Alternatively, the raster image data generation apparatuses 14 may be, in contrast to cloud servers, so-called “on-premise” computers communicably connected to the user terminal 12 and the image forming apparatus 16 through a LAN.

The raster image data generation apparatuses 14 each include, for example, a communication interface such as a network adapter, a memory such as an HDD, an SSD, an eMMC, a ROM, or a RAM, and a processor such as a CPU.

The image forming apparatus 16 is, for example, a printer or a multifunction device capable of performing a printing process. The image forming apparatus 16 may be a production printer (a printer for commercial purposes), instead. Alternatively, the image forming apparatus 16 may be a continuous-sheet printer that performs a printing process on continuous paper, which is a long strip of paper. As described above, the image forming apparatus 16 includes the controller 18 and the printer 20.

The controller 18 is a computer that performs various processes relating to a print job from the user terminal 12. The controller 18 may be a server computer, too. In this case, the controller 18 and the printer 20 are communicably connected to each other over the communication network such as the Internet or a mobile communication network. Details of the configuration of the controller 18 and a process performed by the controller 18 will be described later.

The printer 20 includes printheads, ink cartridges, and a paper feed mechanism and performs a printing process on the basis of raster image data transmitted from the controller 18. The printer 20 according to the present exemplary embodiment performs printing using an inkjet method, but may use a laser method, instead.

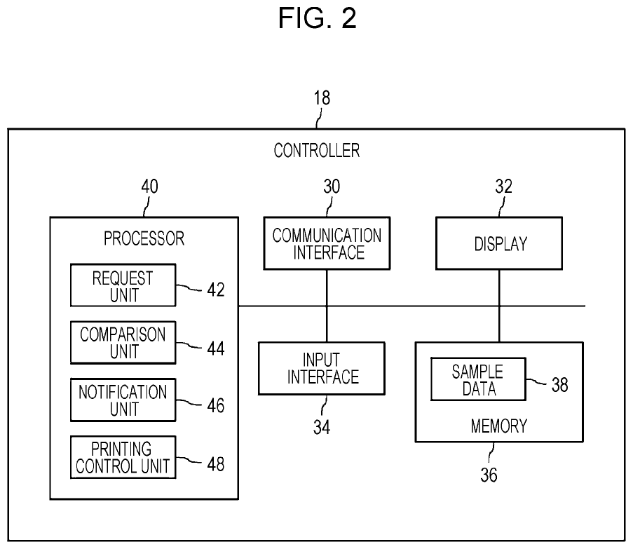

FIG. 2 is a schematic diagram illustrating the configuration of the controller 18.

A communication interface 30 includes, for example, a network adapter. The communication interface 30 has a function of communicating with the user terminal 12, the raster image data generation apparatuses 14, and the printer 20 through a LAN or the like.

A display 32 includes, for example, a liquid crystal panel. The display 32 displays various screens relating to a printing process, such as a setting screen and a management screen for input print jobs and notification screens for the user. When the controller 18 is a server computer, the display of the user terminal 12 plays a role of the display 32.

An input interface 34 includes, for example, a touch panel or buttons. The input interface 34 receives instructions from the user. For example, the user can input, using the input interface 34, an instruction to activate the controller 18 (and the printer 20) or an instruction relating to an input print job. In particular, the user can make settings (details will be described later) relating to imposition for an input print job, for example, using the input interface 34. The input interface 34 may also include a device for reading a storage medium, such as a compact disc (CD) drive or a digital versatile disc (DVD) drive. A print job may be input to the controller 18 when the device for reading a storage medium reads a storage medium storing the print job. When the controller 18 is a server computer, the input interface of the user terminal 12 can play a role of the input interface 34.

A memory 36 includes, for example, an HDD, an SSD, an eMMC, a ROM, or a RAM. The memory 36 stores a program for processing an image, which is used to operate the components of the controller 18. The memory 36 temporarily stores input print jobs and raster image data generated on the basis of the print job. As illustrated in FIG. 2, the memory 36 stores sample data 38.

The sample data 38 indicates features of a print result desired (by the user) with a print job input by the user to the controller 18. That is, sample data 38 is based on a print job, and sample data 38 corresponding to different print jobs can be different pieces of data. Sample data 38 corresponding to a print job is input to the controller 18 and stored in the memory 36 before or at the same time as the user inputs the print job to the controller 18.

This is just an example, but when a print job relates to reprinting of an item (e.g., an advertisement or a booklet) printed in the past, data indicating features of the item printed in the past may be the sample data 38. For example, the sample data 38 may be scan data obtained as a result of scanning of a desired print result (e.g., the item printed in the past). Alternatively, the sample data 38 may be raster image data generated when a desired print result is obtained. Alternatively, the sample data 38 may be metadata indicating features of a desired print result.

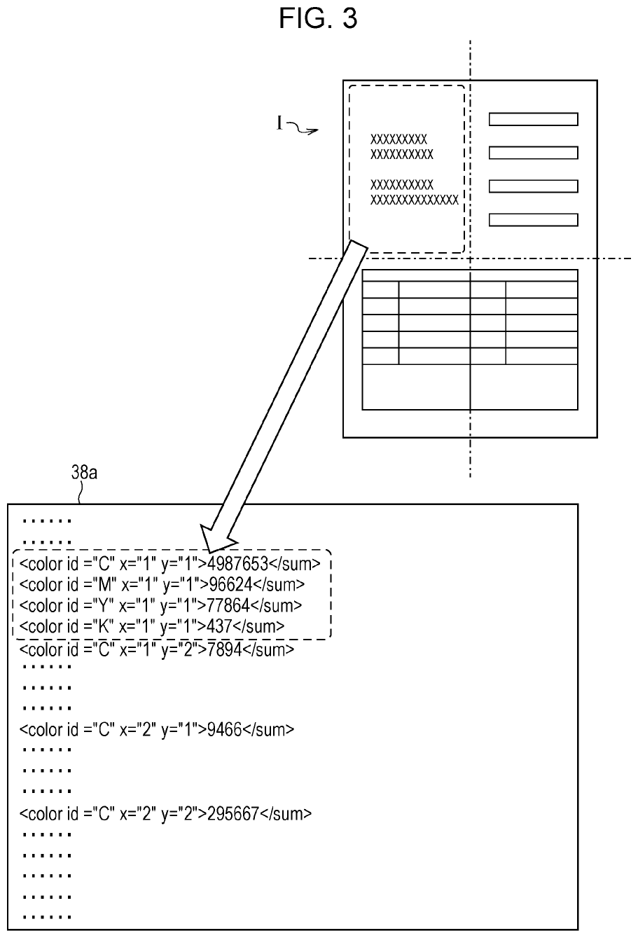

FIG. 3 is a conceptual diagram illustrating an example of metadata 38a as the sample data 38. In the example illustrated in FIG. 3, image data I (e.g., scan data or raster image data) relating to a desired print result is divided into plural regions, and the number of pixels of each of color components collected in each region is used to construct the metadata 38a. Although the image data I is divided into four regions by dash-dot lines in the example illustrated in FIG. 3 for the sake of simplicity, the image data I is divided more finely in practice. An upper-left region of the image data I is indicated by X=1 and Y=1, a lower-left region of the image data I is indicated by X=1 and Y=2, an upper-right region of the image data I is indicated by X=2 and Y=1, and a lower-right region of the image data I is indicated by X=2 and Y=2.

The metadata 38a illustrated in FIG. 3 indicates the number of pixels of each of the color components, namely cyan (C), magenta (M), yellow (Y), and key plate (K; black), in each region. For example, in the metadata 38a, the number of pixels of the color component C is 4,987,653, the number of pixels of the color component M is 96,624, the number of pixels of the color component Y is 77,846, and the number of pixels of the color component K is 437 in the region indicated by X=1 and Y=1. Alternatively, another apparatus may generate metadata, or the controller 18 may generate metadata on the basis of image data regarding a desired item.

FIG. 2 will be referred to again. A processor 40 refers to a processor in a broad sense. The processor includes at least a general processor (e.g., a CPU) or a dedicated processor (e.g., a graphics processing unit (GPU), an application-specific integrated circuit (ASIC), a field-programmable gate array (FPGA), or a programmable logic device). The processor 40 need not necessarily be a single processor and may be plural processors that cooperate with each other from physically distant places. As illustrated in FIG. 2, the processor 40 functions as a request unit 42, a comparison unit 44, a notification unit 46, and a printing control unit 48 in accordance with the program for processing an image, the program being stored in the memory 36.

The request unit 42 receives a print job from the user, transmits the print job to the raster image data generation apparatuses 14 included in the image processing system 10, and requests the raster image data generation apparatuses 14 to generate raster image data relating to the print job. In response to the request from the request unit 42, the raster image data generation apparatuses 14 generate raster image data on the basis of the transmitted print job. That is, the raster image data generation apparatuses 14 generate raster image data on the basis of the same print job. The raster image data generation apparatuses 14 transmit the generated raster image data to the controller 18, and the controller 18 receive the raster image data from the raster image data generation apparatuses 14. Although the user inputs a print job to the controller 18 and the request unit 42 transmits the print job to the raster image data generation apparatuses 14 in the present exemplary embodiment, the user may directly transmit a print job to the raster image data generation apparatuses 14. In this case, too, the raster image data generation apparatuses 14 generate raster image data on the basis of the transmitted print job and transmit the raster image data to the controller 18.

The comparison unit 44 compares plural pieces of raster image data generated by the raster image data generation apparatuses 14 in accordance with a print job and sample data 38 corresponding to the print job, the sample data 38 being stored in the memory 36. When the sample data 38 is scan data, for example, the comparison unit 44 performs a process for comparing images between the scan data, which is the sample data 38, and the plural pieces of raster image data. A known method may be employed for the process for comparing images, and detailed description thereof is omitted. When the sample data 38 is metadata, for example, the comparison unit 44 compares the metadata, which is the sample data 38, and the same kind of metadata obtained from the plural pieces of raster image data. When the sample data 38 is the metadata 38a illustrated in FIG. 3, for example, the comparison unit 44 also divides each of the plural pieces of raster image data into four regions, generates metadata indicating the number of pixels of each of the color components in each region, and compares the metadata, which is the sample data 38, and the metadata of the plural pieces of raster image data (e.g., detects a difference in the number of pixels of each of the color components).

The notification unit 46 notifies the user of a result of comparison performed by the comparison unit 44 between sample data 38 and plural pieces of raster image data. Any method may be used to notify the user of the result of comparison. Although the notification unit 46 displays a comparison result notification screen on the display 32 of the controller 18 in the present exemplary embodiment, the notification unit 46 may, for example, display the comparison result notification screen on the display of the user terminal 12, instead.

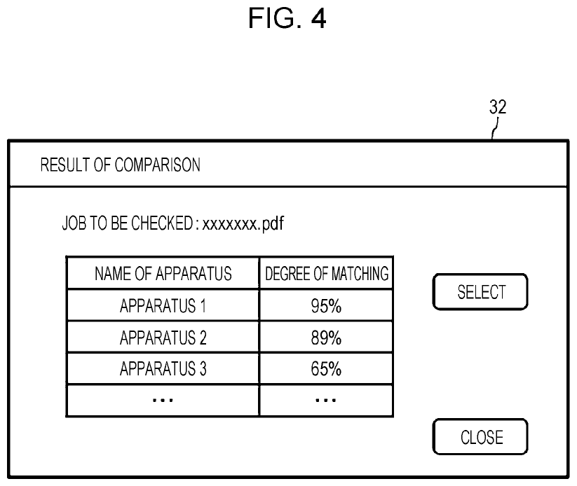

FIG. 4 is a diagram illustrating an example of a comparison result notification screen displayed on the display 32. The comparison result notification screen includes information for identifying a print job for which comparison has been performed (a name of data handled in the print job in the example illustrated in FIG. 4) and a result of comparison performed by the comparison unit 44 between sample data 38 and pieces of raster image data generated by the raster image data generation apparatuses 14. In FIG. 4, Apparatuses 1 to 3 are raster image data generation apparatuses 14.

As illustrated in FIG. 4, the notification unit 46 may notify the user of degrees of matching between the sample data 38 and the pieces of raster image data generated by the raster image data generation apparatuses 14 as a result of comparison. In the example illustrated in FIG. 4, the degrees of matching are expressed in percentage. A degree of matching of 100% indicates that sample data 38 and raster image data perfectly match.

If there is a difference between sample data 38 and raster image data as a result of comparison (if sample data 38 and raster image data do not perfectly match), the notification unit 46 may notify the user of the difference between the sample data 38 and the raster image data while highlighting a region where the difference exists. For example, the notification unit 46 displays plural pieces of raster image data generated by the raster image data generation apparatuses 14 on the comparison result notification screen and highlights regions of the plural pieces of raster image data where differences from the sample data 38 exist. The notification unit 46 may highlight the regions by flashing the regions or displaying icons (arrows etc.) near the regions, for example, but a method used is not limited to these.

After the notification unit 46 notifies the user of a result of comparison between sample data 38 and plural pieces of raster image data, the user can select, on the basis of the result of comparison, a raster image data generation apparatus 14 that is to generate raster image data based on the print job. More specifically, the user can select a raster image data generation apparatus 14 that generates raster image data with which a print result that is fairly similar to (perfectly matches, ideally) the sample data 38. If the user is notified of degrees of matching between sample data 38 and plural pieces of raster image data as a result of comparison, the user can select a raster image data generation apparatus 14 that has generated a piece of raster image data whose degree of matching is the highest. If the user is notified of highlighted regions where differences between sample data 38 and raster image data exist as a result of comparison, the user can select a raster image data generation apparatus 14 on the basis of the regions.

As illustrated in FIG. 4, the comparison result notification screen may include a selection button in order to enable the user to select a raster image data generation apparatus 14 that is to generate raster image data based on the print job.

FIG. 2 will be referred to again. The printing control unit 48 transmits, to the printer 20, raster image data received from the raster image data generation apparatuses 14 and causes the printer 20 to perform a printing process. In particular, with respect to a print job for which sample data 38 and raster image data have been compared with each other, the printing control unit 48 transmits, to the printer 20, only a piece of raster image data received from a raster image data generation apparatus 14 selected by the user on the basis of a notification from the notification unit 46 and causes the printer 20 to perform the printing process. As a result, the printer 20 can obtain a print result desired by the user.

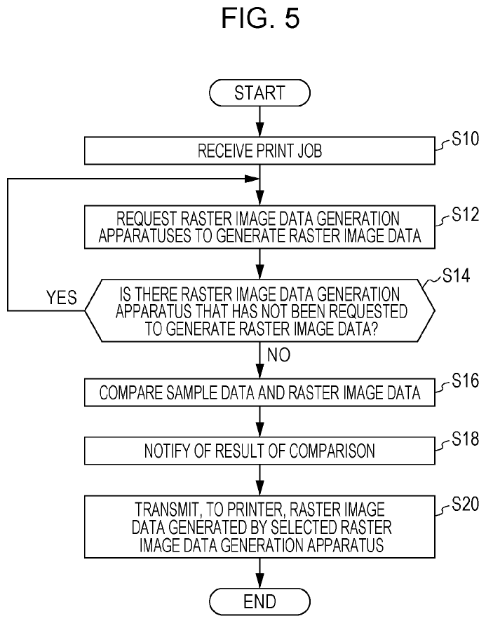

An example of a process performed by the controller 18 according to the first exemplary embodiment will be described hereinafter with reference to a flowchart of FIG. 5. It is assumed that sample data 38 corresponding to a print job relating to the process is already stored in the memory 36 at a beginning of the flowchart of FIG. 5.

In step S10, the controller 18 receives a print job from the user.

In step S12, the request unit 42 transmits the print job received in step S10 to one of the raster image data generation apparatuses 14 and requests the raster image data generation apparatus 14 to generate raster image data.

In step S14, the request unit 42 determines whether there is at least one raster image data generation apparatus 14 that has not been requested to generate raster image data for the print job received in step S10 among the raster image data generation apparatuses 14 included in the image processing system 10. If so, the process returns to step S12, and the request unit 42 transmits the print job to another raster image data generation apparatus 14 and requests this raster image data generation apparatus 14 to generate raster image data. If all the raster image data generation apparatuses 14 included in the image processing system 10 have been requested to generate raster image data for the print job, the process proceeds to step S16.

In step S16, the comparison unit 44 compares the sample data 38 and plural pieces of raster image data received from the raster image data generation apparatuses 14.

In step S18, the notification unit 46 notifies the user of a result of the comparison performed by the comparison unit 44 in step S16.

In step S20, the printing control unit 48 transmits, to the printer 20, raster image data generated by the raster image data generation apparatus 14 selected by the user on the basis of the result of comparison provided in step S18 and causes the printer 20 to perform a printing process. Thereafter, the printing control unit 48 transmits only a piece of raster image data generated by the selected raster image data generation apparatus 14 to the printer 20 for the print job received in step S10.

### Second Exemplary Embodiment

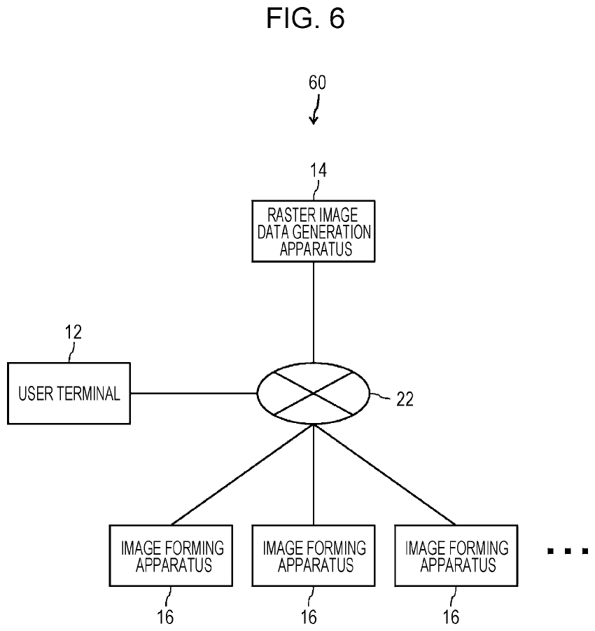

FIG. 6 is a schematic diagram illustrating the configuration of an image processing system 60 according to a second exemplary embodiment. The image processing system 60 includes a user terminal 12 used by the user, a raster image data generation apparatus 14 as an information processing apparatus, and image forming apparatuses 16. The user terminal 12, the raster image data generation apparatus 14, and the image forming apparatuses 16 are communicably connected to one another over a communication network 22 such as a LAN, the Internet, or a mobile communication network.

The image processing system 60 is a system that performs, on the basis of a print job from the user, a printing process, in which the image forming apparatuses 16 print, on a print medium, image data based on the print job. More specifically, the user terminal 12 transmits a print job to the raster image data generation apparatus 14, the raster image data generation apparatus 14 generates, on the basis of the print job, raster image data, which is image data that can be recognized by the image forming apparatuses 16, and transmits the raster image data to the image forming apparatuses 16, and one of the image forming apparatuses 16 performs a printing process on the basis of the raster image data.

Plural image forming apparatuses 16 are provided in the image processing system 60. A selected one of the image forming apparatuses 16, therefore, performs a printing process. Here, even when the image forming apparatuses 16 perform a printing process on the basis of the same raster image data, print results obtained by the image forming apparatuses 16 might be slightly different from one another. For example, colors and printing positions of objects might be slightly different between the image forming apparatuses 16. This is due to, but not limited to, differences between printers of the image forming apparatuses 16 and additional processing (e.g., color correction) performed by the image forming apparatuses 16 on the received raster image data.

The image processing system 60 assists the user in selecting an image forming apparatus 16 that can obtain a print result desired by the user, details of which will be described later.

The configuration of the user terminal 12 is the same as in the first exemplary embodiment, and description thereof is omitted. As in the first exemplary embodiment, the image forming apparatuses 16 each include a controller 18 and a printer 20 (refer to FIG. 2) and perform a printing process on the basis of raster image data transmitted from the raster image data generation apparatus 14. In the second exemplary embodiment, however, memories 36 of the image forming apparatuses 16 do not store sample data 38, and a processor 40 does not have functions of the request unit 42, the comparison unit 44, and the notification unit 46.

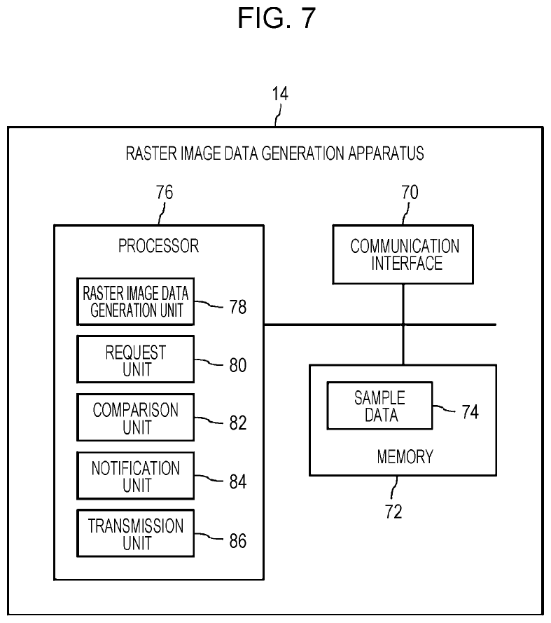

FIG. 7 is a schematic diagram illustrating the configuration of the raster image data generation apparatus 14. As in the first exemplary embodiment, the raster image data generation apparatus 14 is an apparatus other than the image forming apparatuses 16 and performs the process for generating raster image data on the basis of a print job. The raster image data generation apparatus 14 may be a server computer communicably connected to the user terminal 12 and the image forming apparatuses 16 over the Internet. More specifically, the raster image data generation apparatus 14 may be a cloud server that provides the process for generating raster image data as a cloud service. Alternatively, the raster image data generation apparatus 14 may be, in contrast to a cloud server, a so-called “on-premise” computer communicably connected to the user terminal 12 and the image forming apparatuses 16 through a LAN.

A communication interface 70 includes, for example, a network adapter. The communication interface 70 achieves a function of communicating with the user terminal 12 and the image forming apparatuses 16 through the LAN or the like.

A memory 72 includes, for example, an HDD, an SSD, an eMMC, a ROM, or a RAM. The memory 72 stores a program for processing information, which is used to operate the components of the raster image data generation apparatus 14. The memory 72 also temporarily stores input print jobs and the like. As illustrated in FIG. 7, the memory 72 stores sample data 74.

The sample data 74 indicates, as with the sample data 38 according to the first exemplary embodiment, features of a print result desired (by the user) with a print job input by the user to the image forming apparatuses 16. That is, sample data 74 is based on a print job, and sample data 74 corresponding to different print jobs can be different pieces of data. Sample data 74 corresponding to a print job is input to the raster image data generation apparatus 14 and stored in the memory 72 before or at the same time as the user inputs the print job to the raster image data generation apparatus 14.

As with the sample data 38 according to the first exemplary embodiment, the sample data 74 may be, for example, scan data obtained as a result of scanning of a desired print result. Alternatively, the sample data 74 may be raster image data generated when a desired print result is obtained. Alternatively, the sample data 74 may be metadata indicating features of a desired print result (refer to FIG. 3).

A processor 76 refers to a processor in a broad sense. The processor includes at least a general processor (e.g., a CPU) or a dedicated processor (e.g., a GPU, an ASIC, an FPGA, or a programmable logic device). The processor 76 need not necessarily be a single processor and may be plural processors that cooperate with each other from physically distant places. As illustrated in FIG. 7, the processor 76 functions as a raster image data generation unit 78, a request unit 80, a comparison unit 82, a notification unit 84, and a transmission unit 86 in accordance with the program for processing an image, the program being stored in the memory 72.

The raster image data generation unit 78 generates raster image data in accordance with a print job transmitted from the user terminal 12.

After the raster image data generation unit 78 generates raster image data, the request unit 80 transmits the raster image data to the image forming apparatuses 16 included in the image processing system 10 and requests the image forming apparatuses 16 to generate processing result image data, which is image data indicating results of processing performed by the image forming apparatuses 16 on the basis of the raster image data. In response to the request from the request unit 80, the image forming apparatuses 16 generate processing result image data on the basis of the transmitted raster image data. That is, the image forming apparatuses 16 generate processing result image data on the basis of the same raster image data.

Processing result image data may be scan data obtained as a result of scanning of a print result printed by the printer 20 on a print medium on the basis of raster image data. In this case, the image forming apparatuses 16 may have a configuration for automatically scanning the print medium after the printing. Alternatively, processing result image data may be post-processing raster image data, which is obtained by processing raster image data input to the image forming apparatuses 16 (more specifically, controllers 18) using the controllers 18. Alternatively, processing result image data may be metadata (e.g., data similar to the metadata 38a illustrated in FIG. 3) indicating features of post-processing raster image data.

The image forming apparatuses 16 transmit the generated processing result image data to the raster image data generation apparatus 14, and the raster image data generation apparatus 14 receives the processing result image data from the image forming apparatuses 16.

The comparison unit 82 compares plural pieces of processing result image data generated by the image forming apparatuses 16 in accordance with raster image data generated by the raster image data generation unit 78 and sample data 74 corresponding to the raster image data (i.e., a print job), the sample data 74 being stored in the memory 72. Details of a process for comparing sample data 74 and processing result image data is the same as in the first exemplary embodiment, and description thereof is omitted.

The notification unit 84 notifies the user of a result of comparison performed by the comparison unit 82 between sample data 74 and plural pieces of processing result image data. Any method may be used to notify the user of a result of comparison. In the present exemplary embodiment, the notification unit 84 displays a comparison result notification screen on the display of the user terminal 12. As in the first exemplary embodiment, the comparison result notification screen may be the screen illustrated in FIG. 4. In this case, Apparatuses 1 to 3 are image forming apparatuses 16.

As in the first exemplary embodiment, the notification unit 84 may notify the user of degrees of matching between the sample data 74 and the plural pieces of processing result image data generated by the image forming apparatuses 16 as a result of comparison. As in the first exemplary embodiment, if there is a difference between the sample data 74 and the processing result image data as a result of comparison (if the sample data 74 and the processing result image data do not perfectly match), the notification unit 84 may notify the user of the difference between the sample data 74 and the processing result image data while highlighting a region where the difference exists.

After the notification unit 84 notifies the user of a result of comparison between sample data 74 and plural pieces of processing result image data, the user can select, on the basis of the result of comparison, an image forming apparatus 16 that is to perform a printing process based on the print job. More specifically, the user can select an image forming apparatus 16 that can obtain a print result which is fairly similar to (perfectly matches, ideally) the sample data 74. If the user is notified of degrees of matching between sample data 74 and processing result image data as a result of comparison, the user can select an image forming apparatus 16 that has generated a piece of processing result image data whose degree of matching is the highest. If the user is notified of highlighted regions where differences between sample data 74 and processing result image data exist as a result of comparison, the user can select an image forming apparatus 16 on the basis of the regions.

As illustrated in FIG. 4, the comparison result notification screen may include a selection button in order to enable the user to select an image forming apparatus 16 that is to perform a printing process based on the print job.

The transmission unit 86 transmits raster image data generated by the raster image data generation unit 78 to the image forming apparatuses 16 and causes the image forming apparatuses 16 to perform a printing process. In particular, with respect to a print job for which sample data 74 and processing result image data have been compared with each other, the transmission unit 86 transmits raster image data to only an image forming apparatus 16 selected by the user on the basis of a notification from the notification unit 84 and causes the image forming apparatus 16 to perform a printing process. As a result, the image forming apparatus 16 can obtain a print result desired by the user.

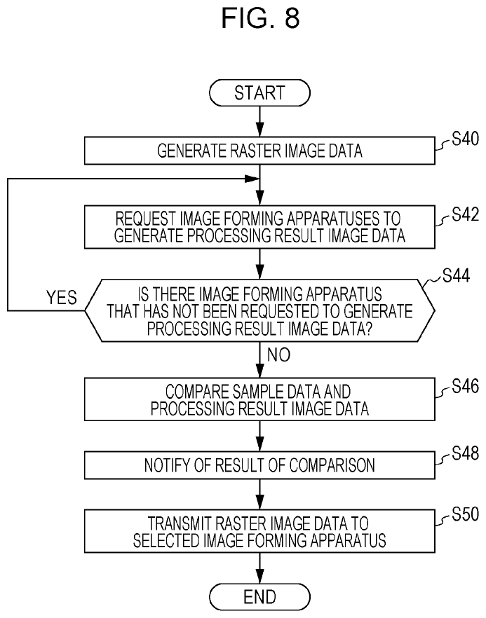

An example of a process performed by the raster image data generation apparatus 14 according to the second exemplary embodiment will be described hereinafter with reference to a flowchart of FIG. 8. It is assumed that sample data 74 corresponding to a print job relating to the process is already stored in the memory 72 at a beginning of the flowchart of FIG. 8.

In step S40, the raster image data generation unit 78 receives a print job from the user and generates raster image data based on the print job.

In step S42, the request unit 80 transmits the raster image data generated in step S40 to one of the image forming apparatuses 16 and requests the image forming apparatus 16 to generate processing result image data.

In step S44, the request unit 80 determines whether there is at least one image forming apparatus 16 that has not been requested to generate processing result image data for the print job received in step S40 among the image forming apparatuses 16 included in the image processing system 60. If so, the process returns to step S42, and the request unit 80 transmits the raster image data to another image forming apparatus 16 and requests this image forming apparatus 16 to generate processing result image data. If all the image forming apparatuses 16 included in the image processing system 60 have been requested to generate processing result image data, the process proceeds to step S46.

In step S46, the comparison unit 82 compares the sample data 74 and plural pieces of processing result image data received from the image forming apparatuses 16.

In step S48, the notification unit 84 notifies the user of a result of the comparison performed by the comparison unit 82 in step S46.

In step S50, the transmission unit 86 transmits the raster image data to an image forming apparatus 16 selected by the user on the basis of the result of comparison provided in step S48 and causes the image forming apparatus 16 to perform a printing process. Thereafter, the transmission unit 86 transmits raster image data to only the selected image forming apparatus 16 for the print job received in step S40.

Although exemplary embodiments of present disclosure have been described above, the present disclosure is not limited to the above exemplary embodiments, and the above exemplary embodiments may be modified in various ways without deviating from the scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
a processor configured to:
receive, from each of a plurality of print image data generation apparatuses that generate a plurality of pieces of print image data on a basis of a print instruction, the plurality of pieces of print image data corresponding to the print instruction; and
notify a user of a result of comparison between sample data indicating a feature of a print result desired with the print instruction and the plurality of pieces of print image data.

2. The image forming apparatus according to claim 1,
wherein the processor is configured to notify the user of, as the result of comparison, degrees of matching between the sample data and the plurality of pieces of print image data.

3. The image forming apparatus according to claim 1,
wherein the processor is configured to notify the user of the result of comparison while highlighting a region where a difference between the sample data and the plurality of pieces of print image data exists.

4. The image forming apparatus according to claim 1,
wherein the processor is configured to cause a printer to print, for the print instruction, only a piece of the print image data from a print image data generation apparatus selected by the user on a basis of the result of comparison.

5. An information processing apparatus comprising:
a processor configured to:
receive, from each of a plurality of image forming apparatuses that print, on a print medium, print image data based on a print instruction, a plurality of pieces of processing result image data, which are image data indicating results of processing performed by the plurality of image forming apparatuses in response to the print instruction; and
notify a user of a result of comparison between sample data indicating a feature of a print result desired with the print instruction and the plurality of pieces of processing result image data.

6. The information processing apparatus according to claim 5,
wherein the processor is configured to notify the user of, as the result of comparison, degrees of matching between the sample data and the plurality of pieces of processing result image data.

7. The information processing apparatus according to claim 5,
wherein the processor is configured to notify the user of the result of comparison while highlighting a region where a difference between the sample data and the plurality of pieces of processing result image data exists.

8. The information processing apparatus according to claim 5,
wherein the processor is configured to transmit, for the print instruction, the print image data to only an image forming apparatus selected by the user on a basis of the result of comparison and cause the image forming apparatus to print the print image data.

9. A non-transitory computer readable medium storing a program causing a computer to execute a process for processing information, the process comprising:
receiving, from each of a plurality of image forming apparatuses that print, on a print medium, print image data based on a print instruction, a plurality of pieces of processing result image data, which are image data indicating results of processing performed by the plurality of image forming apparatuses in response to the print instruction; and
notifying a user of a result of comparison between sample data indicating a feature of a print result desired with the print instruction and the plurality of pieces of processing result image data.
